(19) United States
(12) Patent Application Publication
(10) Pub. No.: US 2024/0012055 A1
(43) Pub. Date: Jan. 11, 2024

(54) METHOD, SYSTEM AND STORAGE MEDIUM FOR SOLVING ELECTRIC FIELD PHYSICAL QUANTITY IN ELECTROCHEMICAL MODEL

(71) Applicant: SHANGHAI MAKESENS ENERGY STORAGE TECHNOLOGY CO., LTD., Shanghai (CN)

(72) Inventors: Danfei Gu, Shanghai (CN); Mingchen Jiang, Shanghai (CN); Siyuan Chen, Shanghai (CN); Xiao Yan, Shanghai (CN); Enhai Zhao, Shanghai (CN)

(21) Appl. No.: 18/218,154

(22) Filed: Jul. 5, 2023

(30) Foreign Application Priority Data
Jul. 5, 2022 (CN) 202210783901.7

(51) Int. Cl. G01R 31/367; G01R 31/3842; G01R 31/36

(52) U.S. Cl. CPC G01R 31/367; G01R 31/3842; G01R 31/3648

(57) ABSTRACT

The invention provides method, system and storage medium for solving electric field physical quantity in an electrochemical model. The method includes selecting a negative or positive electrode region as a calculation region; selecting a solid or liquid phase current as an observed quantity, and a solid- and liquid-phase potentials as a costate variable; inserting nodes between two endpoints of the calculation region, and determining a target value of the observed quantity of each node; constructing N calculation units; sequentially completing shooting of each of the N calculation units until a convergent solution of the target shooting of the N-th calculation unit is obtained, and taking the convergent solution as a deterministic solution of the costate variable; obtaining the physical quantity of each spatial point at the present time according to the observed quantity of the starting point at the present time and the deterministic solution of the costate variable.

### CROSS-REFERENCE TO RELATED PATENT APPLICATION

This application claims priority to and the benefit of Chinese Patent Application No. 202210783901.7, filed Jul. 5, 2022, which are incorporated herein in their entireties by reference.

### FIELD OF THE INVENTION

The invention relates generally the field of batteries, and more particularly to a method, a system, and a storage medium for solving electric field physical quantity in an electrochemical model.

### BACKGROUND OF THE INVENTION

To more clearly understand and monitor the real-time working status of a lithium-ion battery, the electrochemical reaction process of the battery is modeled, and an electrochemical model is established to obtain various physical quantities in the internal space and time of the battery. For example, the electrochemical pseudo-two-dimensional (P2D) model, which is a full-order model, is complex and the simulation is very accurate, but the coupling degree of various physical quantities is high, and the amount of calculation is large.

In the electric field of the P2D model, there are two kinds of carriers, lithium-ions and electrons, and the internal physical quantities include solid-phase ion concentration, liquid-phase ion concentration, solid-phase current, liquid-phase current, solid-liquid two-phase exchange current density, solid-phase potential, liquid phase potential, etc. Each of these quantities is coupled to the other quantities.

In electric field coupling, a series of partial differential equations of boundary value problems needs to be solved. The shooting method is a numerical method for solving boundary value problems. The biggest difficulty is guessing the initial value of the costate variable. If the initial value is not appropriate, the shooting method overflows and fails to converge. For a system with a relatively high degree of nonlinearity, its convergence region will be very small.

The electric field decoupling is carried out by applying the shooting method under the working conditions of large current, high temperature and the like. Due to the high degree of nonlinearity of the governing equation of the full-order electrochemical model, the non-convergence or the exceeding of the expression range of the data type occurs easily during the calculation on hardware and a PC (personal computer) because the initial value is far away from the real solution.

Therefore, a heretofore unaddressed need exists in the art to address the aforementioned deficiencies and inadequacies.

### SUMMARY OF THE INVENTION

In view of the above-noted shortcomings, one of the objectives of this invention is to provide a method and a system for solving electric field physical quantity in an electrochemical model and a storage medium, which are used for solving the problems that the dependence on an initial value is high, the initial value is improper and the non-convergence or data overflow is easy to occur when the electric field decoupling of a full-order electrochemical model of a lithium-ion battery is carried out by using a conventional targeting method.

In one aspect of the invention, the method includes:
selecting a negative electrode region or a positive electrode region of the electrochemical model as a calculation region;
selecting a solid phase current or a liquid phase current as an observed quantity, and a solid-phase potential and a liquid-phase potential as a costate variable;
inserting (N−1) different nodes between two endpoints of the calculation region, and determining a target value of the observed quantity of each node according to a preset interpolation method, wherein N is a number of spatial discrete units;
constructing N calculation units, wherein each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1;
sequentially completing target shooting of each of the N calculation units according to an ascending order, starting from the first calculation unit, until a convergent solution of the target shooting of the N-th calculation unit is obtained, and taking the convergent solution as a deterministic solution of the costate variable of the starting point at the present time; and
obtaining, according to the observed quantity of the starting point at the present time and the deterministic solution of the costate variable, the electric field physical quantity of each spatial point in the calculation region at the present time;

The target shooting of each calculation unit includes performing the target shooting of said calculation unit, starting from an initial trial solution of the target shooting of said calculation unit, to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point; and if said calculation unit is not the first calculation unit, obtaining the initial trial solution of the target shooting of said calculation unit according to the convergent solution of the shooting of the previous calculation unit.

In some embodiments, said determining the target value of the observed quantity of each node according to the preset interpolation method comprises constructing an interpolation function according to the preset interpolation method, wherein values of the interpolation function at the two endpoints of the calculation region are respectively equal to boundary values of the observed quantity in the calculation region, and wherein the preset interpolation method is one of a linear interpolation method, a Lagrange interpolation method and a Newton interpolation method; and calculating the target value of the observed quantity of each node according to the interpolation function.

In some embodiments, said calculating the target value of the observed quantity of each node according to the interpolation function comprises if the observed quantity is the solid-phase current, the target value of the observed quantity at the i-th node is:

$$\frac{{i}_{external}}{L} \times ( L - {x}_{i} ) ,$$

wherein iₑₓₜₑᵣₙₐₗ is an external current, L is a thickness of an electrode, and xᵢ is a distance from the i-th node to a current collector.

In some embodiments, the method further includes if there exists one calculation unit whose shooting overshoots or fails to converge during the target shooting process of the N calculation units, increasing the number of spatially discrete units, reconstructing all the calculation units according to the new number of spatially discrete units, and re-performing the target shooting process starting from the first calculation unit.

In some embodiments, the target shooting of each calculation unit further includes if said calculation unit is the first calculation unit, the initial trial solution of the shooting of said calculation unit is the deterministic solution of the costate variable of which the starting point of the calculation region is at the previous time.

In some embodiments, said performing the target shooting of said calculation unit, from the initial trial solution of the target shooting of said calculation unit, to obtain the convergent solution of the target shooting of said calculation unit comprises:
(a) obtaining a value of the observed quantity of the starting point of said calculation unit at the present time;
(b) setting, according to the initial trial solution of the shooting of said calculation unit, the costate variable of the starting point at the present time;
(c) obtaining, according to the observed quantity and the costate variable of the starting point at the present time and a governing equation of the electrochemical model, the observed quantity of the end point of said calculation unit at the present time;
(d) determining whether an error between the observed quantity of the end point of said calculation unit at the present time and the target value of the observed quantity is within an error range;
(e) if the error is not within the error range, updating the trial solution of the costate variable according to a preset rule, setting the costate variable of the starting point at the present time according to a new trial solution, obtaining the observed quantity of the end point of said calculation unit at the present time according to the new trial solution, determining whether the error between the observed quantity at the present time and the target value of the observed quantity at the end point of the calculation unit is within the error range, and repeating process (a)-(d) until the error is within the error range; and
if the error is within the error range, taking the trial solution as the convergent solution for shooting by the calculation unit.

In some embodiments, said obtaining, according to the observed quantity and the costate variable of the starting point at the present time and the governing equation of the electrochemical model, the observed quantity of the end point of said calculation unit at the present time comprises calculating, from the starting point, the observed quantity and the costate variable of the next spatial point at the present time according to the observed quantity and the costate variable of the present spatial point at the present time, updating the present spatial point with the next spatial point, and repeating the process until the observed quantity and the costate variable of the end point of said calculation unit at the present time are obtained.

In some embodiments, said calculating the observed quantity and the costate variable of the next spatial point at the present time according to the observed quantity and the costate variable of the present spatial point at the present time comprises:
according to the solid phase potential and the liquid phase potential of the present spatial point at the present time, obtaining an overpotential of the present spatial point at the present time by a formula of:

η(x,t)=ϕₛ(x,t)−ϕₑ(x,t)−ocv(x,t);

wherein η is the overpotential, ϕₛ is the solid phase potential, ϕₑ is the liquid phase potential, ocv is an electrode steady state open circuit voltage related to a lithium-ion concentration on surfaces of solid phase particles;
according to the overpotential of the present spatial point at the present time, obtaining an exchange current density of the present spatial point at the present time by a formula of:

$${j}_{n} ( x , t ) = \frac{1}{F} {j}_{0} ( x , t ) ( \frac{{α}^{+} F}{RT} η ( x , t ) ) - exp ( - \frac{{α}^{-} F}{RT} η ( x , t ) ) ] ;$$

wherein α⁺ and α⁻ are transfer coefficients, F is a Faraday constant, R is a molar gas constant, T is an absolute temperature of the battery, and j₀ is the exchanging current density for an electrode reaction in an equilibrium state;
according to the exchange current density of the present spatial point at the present time, calculating the observed quantity of the next spatial point at the present time by using a difference method or a Runge-Kutta method;
according to the observed quantity of the present spatial point at the present time, obtaining a partial derivative of the solid-phase potential of the present spatial point at the present time by a formula of:

$$\frac{\partial {ϕ}_{s}}{\partial x} ( x , t ) = - \frac{{i}_{s} ( x , t )}{k}$$

wherein iₛ is the solid phase current, k is a solid phase conductivity;
calculating the solid phase potential of the next spatial point by using the difference method or the Runge-Kutta method according to the partial derivative of the solid phase potential of the present spatial point at the present time;
obtaining a partial derivative of the liquid phase potential of the present spatial point at the present time according to a formula of:

$$\frac{\partial {ϕ}_{e}}{\partial x} ( x , t ) = - \frac{{i}_{e} ( x , t )}{{σ}^{*} {ε}^{brug}} + \frac{2 RT}{F} ( 1 - {t}_{c} ) \frac{\partial {lnc}_{e}}{\partial x} ( x , t )$$

wherein iₑ is the liquid phase current, t_{c} is the point mobility, cₑ is a liquid phase lithium-ion concentration, σ is a liquid phase conductivity, e is a liquid phase volume fraction, brug is a porous media coefficient; and
calculating the liquid phase potential of the next spatial point by using the difference method or the Runge-Kutta method according to the partial derivative of the liquid phase potential of the present spatial point at the present time.

In another aspect, the invention relates to a system for solving electric field physical quantity in an electrochemical model, wherein a negative electrode region or a positive electrode region of the electrochemical model is selected as a calculation region, a solid phase current or a liquid phase current is selected as an observed quantity, and a solid-phase potential and a liquid-phase potential are selected as a costate variable.

The system comprises an interpolation module, a unit construction module, an improved target shooting module, and a physical quantity calculation module.

The interpolation module is configured to insert (N−1) different nodes between two endpoints of the calculation region and determine a target value of the observed quantity of each node according to a preset interpolation method, wherein N is a number of spatial discrete units.

The unit construction module is configured to construct N calculation units, wherein each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1.

The improved target shooting module is configured to complete, staring from the first calculation unit, target shooting of each of the N calculation units in turn according to an ascending order until a convergent solution of the target shooting of the N-th calculation unit is obtained, and take the convergent solution as a deterministic solution of the costate variable of the starting point at the present time.

The physical quantity calculation module is configured to obtain, according to the observed quantity of the starting point at the present time and the deterministic solution of the costate variable, the electric field physical quantity of each spatial point of the calculation region at the present time.

The improved target shooting module includes a target shooting unit, configured to complete the shooting of each calculation unit, wherein the target shooting unit is further configured to perform, starting from an initial trial solution of the target shooting of said calculation unit, the target shooting of said calculation unit to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point; and if said calculation unit is not the first calculation unit, obtaining the initial trial solution of the target shooting of said calculation unit according to the convergent solution of the shooting of the previous calculation unit.

In yet another aspect, the invention relates to a non-transitory tangible computer-readable storage medium, storing a computer program therein, wherein when the computer program is executed by a processor, the method for solving electric field physical quantities in the electrochemical model according claim 1 is realized.

Compared with the prior art, the method, the device and the storage medium for solving the electric field physical quantity in the electrochemical model provided by the invention can at least bring the following beneficial effects:

The method avoids the phenomena that the conventional target shooting method has high dependence on the initial trial solution and data overflow or non-convergence easily occurs in the target shooting process through multiple times of the target shooting, and can successfully realize the electric field decoupling of the full-order electrochemical model under the extreme working conditions of large current, high temperature and the like. The method has the advantages of low consumption of storage resources and high calculation precision, compared to the conventional target shooting method.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 is a flowchart of a method for solving electric field physical quantity in an electrochemical model according to embodiments of the invention.

FIG. 2 is a schematic structural diagram of a system for solving electric field physical quantity in an electrochemical model according to embodiments of the invention.

FIG. 3 is a schematic structural diagram of a P2D model of a lithium-ion battery.

FIG. 4 is a schematic diagram of an improved target shooting process according to embodiments of the invention.

### DETAILED DESCRIPTION OF THE INVENTION

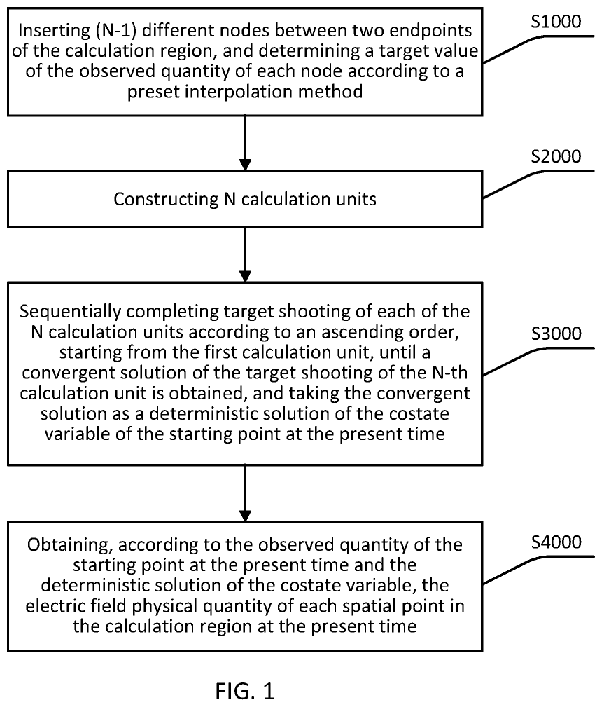

Embodiments of the invention are described below through specific examples in conjunction with the accompanying drawings in FIGS. 1-4, and those skilled in the art can easily understand other advantages and effects of the invention from the content disclosed in this specification. The invention can also be implemented or applied through other different specific implementations, and various modifications or changes can be made to the details in this specification according to different viewpoints and applications without departing from the spirit of the invention. It should be noted that, in the case of no conflict, the following embodiments and features in the embodiments can be combined with each other.

It should be noted that the drawings provided in the following embodiments are merely illustrative in nature and serve to explain the principles of the invention, and are in no way intended to limit the invention, its application, or uses. Only the components related to the invention are shown in the drawings rather than the number, shape and size of the components in actual implementations. For components with the same structure or function in some figures, only one of them is schematically shown, or only one of them is marked. They do not represent the actual structure of the product. Dimensional drawing, the type, quantity and proportion of each component can be changed arbitrarily in its actual implementations. More complicate component layouts may also become apparent in view of the drawings, the specification, and the following claims.

The terminology used herein is for the purpose of describing particular embodiments only and is not intended to be limiting of the invention. As used herein, “a” not only means “only one”, but also means “more than one”. The term “and/or” used in the description of the present application and the appended claims refers to any combination and all possible combinations of one or more of the associated listed items, and includes these combinations. The terms “first”, “second”, etc. are only used for distinguishing descriptions, and should not be construed as indicating or implying relative importance.

It should be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

In order to more clearly illustrate the embodiments of the invention or the technical solutions in the prior art, the following description will explain the specific embodiments of the invention with reference to the accompanying drawings. It is evident that the drawings in the following description are only examples of the invention, from which other drawings and other embodiments can be obtained by a person skilled in the art without inventive effort.

As described above, the electric field physical quantities such as current, potential and others at each spatial point in the electrochemical model can be solved using the target shooting method. However, the conventional target shooting method has high dependency on the initial trial solution of costate variables. If the initial trial solution is not appropriate, it will lead to the overflow of intermediate calculation data, and the shooting will not converge.

In view of the foregoing, the invention improves the target shooting method, and converts a target shooting with a fixed tracking length into multiple target shootings with different tracking lengths, and the tracking length gradually increases to the maximum tracking length. Starting from the target shooting with the smallest tracking length, even if the initial trial solution of a first shooting is not very accurate, the data overflowing in the target shooting can be prevented due to the small tracking length. The initial trial solution of the target shooting of the calculation unit is obtained according the convergent solution of the previous calculation unit, so that the initial trial solution used in the subsequent target shooting is closer to the true value, and the subsequent target shooting can be ensured not to overflow even if the tracking length is increased.

The embodiments of the invention are described in detail below by taking a pseudo-two-dimensional (P2D) model of a lithium-ion battery as an example.

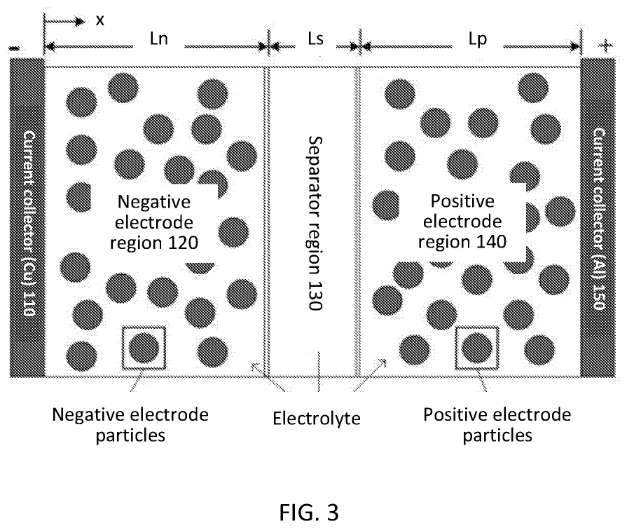

The schematic structure of the P2D model is shown in FIG. 3. The basic units of the lithium-ion battery are respectively a copper current collector 110, a negative electrode 120, a separator 130, a positive electrode 140 and an aluminum current collector 150. From the perspective of spatial distribution, a lithium-ion battery 110 can be divided into three domains/regions, that is, a negative electrode region 120, a separator region 130, and a positive electrode region 140. The width of the positive electrode region is Lp, the width of the negative electrode region is Ln, and the width of the separator region is Ls.

In some embodiments, a plane coordinate system is established for the battery, and the x-axis is established along the direction from the negative electrode 130 to the positive electrode 150 in the embodiments. It can also be reversed in other embodiments, and there is no limitation to this establishment.

In one embodiment, as shown in FIG. 1, the method solving electric field physical quantities in the electrochemical model includes the following steps.

In one embodiment, a negative electrode region or a positive electrode region is selected as a calculation region. The calculation region has two endpoints, one of which is designated as a start point and the other as an end point.

As shown in FIG. 3, one endpoint of the negative electrode region 120 is proximal to the first current collector 110, i.e., copper current collector (Cu), and the other endpoint is distal to the first current collector 110 and close to the separator region 130. One endpoint of the positive electrode region 140 is proximal to the second current collector 150, i.e., aluminum current collector (Al), and the other endpoint is distal to the second current collector 150 and close to the separator region 130.

In one embodiment, a solid-phase current or a liquid-phase current is selected as an observed quantity, and a solid-phase potential and a liquid-phase potential are selected as a costate variable.

The boundary values of the observed quantity in the calculation region, that is, the values of the observed quantity at the two endpoints of the calculation region are definite and known, but the costate variable is not certain.

If the starting point of the calculation region is an endpoint proximal to a current collector and the end point of the calculation region is an endpoint distal to the current collector, the solid-phase current of the starting point at the present time is equal to an external current at the present time and the liquid-phase current of the starting point at the present time is 0, and the solid-phase current of at the present time is 0 and the liquid-phase current of the end point at the present time is the external current at the present time.

If the starting point of the calculation region is an endpoint distal to a current collector and the end point of the calculation region is an endpoint proximal to the current collector, the solid-phase current of the starting point at the present time is 0 and the liquid-phase current of the starting point at the present time is equal to an external current at the present time, and the solid-phase current of at the present time is equal to an external current at the present time and the liquid-phase current of the end point at the present time is 0.

At step S1000, (N−1) different nodes are inserted between two endpoints of the calculation region, and a target value of the observed quantity of each node is determined according to a preset interpolation method, wherein N is a number of spatial discrete units.

Specifically, several nodes may be inserted at equal or unequal intervals between two end points of the calculation region.

At step S1100, an interpolation function is constructed according to the preset interpolation method, wherein values of the interpolation function at the two endpoints of the calculation region are respectively equal to boundary values of the observed quantity in the calculation region, and wherein the preset interpolation method is one of a linear interpolation method, a Lagrange interpolation method and a Newton interpolation method.

At step S1200, the target value of the observed quantity of each node is calculated according to the interpolation function.

The target values of the observed quantity at the two endpoints of the calculation region are also the boundary values of the observed quantity in the calculation region.

In order to avoid the extreme value of the interpolation function in the calculation region that causes the target shooting not to converge, it is preferable to set the threshold range according to the boundary value of the observed quantity in the calculation region, such as a minimum value and a maximum value, and limit the value of the interpolation function at each node not exceeding the threshold range.

At step S2000, N calculation units are constructed.

Each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1.

Specifically, all the calculation units have the same starting point that is the starting point of the calculation region, which are collectively referred to as the starting point in the following. The end points of all the calculation units are different. Along the direction from the starting point to the end point of the calculation region, the end point of the first calculation unit is the first node, the end point of the i-th calculation unit is the i-th node, and so on, the end point of the N-th calculation unit is the end point of the calculation region.

At step S3000, starting from the first calculation unit, target shooting of each of the N calculation units sequentially completed according to an ascending order until a convergent solution of the target shooting of the N-th calculation unit is obtained, and the convergent solution is taken as a deterministic solution of the costate variable of the starting point at the present time.

The target shooting of each calculation unit includes:
At step S3100, starting from an initial trial solution of the target shooting of said calculation unit, the target shooting of said calculation unit is performed to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point;
At step S3200, if said calculation unit is not the first calculation unit, the initial trial solution of the target shooting of said calculation unit is obtained according to the convergent solution of the shooting of the previous calculation unit.

The convergent solution of the target shooting of the immediately previous calculation unit can be directly used as the initial trial solution of the target shooting of the present calculation unit, or the convergent solution of the target shooting of the immediately previous calculation unit can be slightly processed to obtain the initial trial solution of the target shooting of the present calculation unit.

If the calculation unit is the first calculation unit, the initial trial solution of the target shooting of the calculation unit can be obtained according to the empirical method or the reduced-order model.

The boundary value of the observed quantity at each calculation unit, i.e., the target value of the observed quantity at the starting point of the calculation unit and the end point of the calculation unit, is determined before the target shooting in step S1000.

Each calculation unit adopts the conventional shooting method to shoot a target from the starting point to the end point of the calculation unit, and the target is the target value of the observed quantity at the end point of the calculation unit. Starting from the initial trial solution of the target shooting of the calculation unit, the convergent solution of the target shooting is obtained through multiple iterations.

The initial trial solution is the first trial solution of the costate variable at the starting point used by the target shooting of the calculation unit. During the target shooting process, the trial solution is adjusted according to a certain rule, so as to obtain a trial solution that makes the value of the observed quantity at the end point of the calculation unit converge to the target value of the observed quantity at the corresponding point. The trial solution is the convergent solution obtained in the shooting step.

The Nth calculation unit is the calculation region, so the convergent solution of the target shooting of the N-th calculation unit is essentially the deterministic solution of the costate variable of the starting point is at the present time.

At step S4000, the electric field physical quantity of each spatial point in the calculation region at the present time is obtained according to the observed quantity of the starting point at the present time and the deterministic solution of the costate variable, the electric field physical quantity of each spatial point in the calculation region at the present time.

The electric field physical quantity includes, but are not limited to, the solid phase current, the liquid phase current, the solid phase potential, and the liquid phase potential.

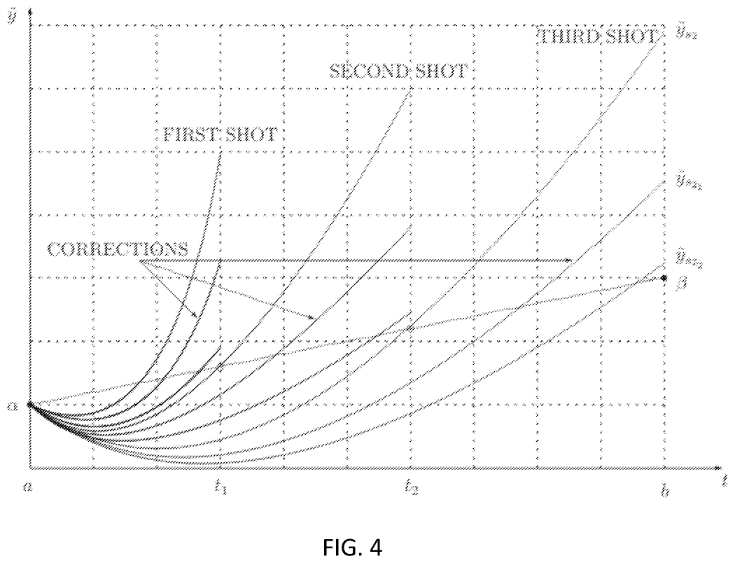

As an example, shown in FIG. 4, the boundary of the calculation region is two points a and b, point a is the starting point, point b is the end point of the calculation region, and the boundary values of the observed quantity in the calculation region are predetermined, for example, the value of point a is a, the value of point b is p. If the deterministic solution of the costate variable at point a (starting point) is obtained according to the shooting method, the value of the observed quantity obtained according to the deterministic solution at point b (i.e., the end point of the calculation region) converges to p (the target value of the observed quantity at point b).

Two nodes t₁ and t₂ are inserted between the two points a and b, and the target values of the observed quantity at the two nodes can be obtained by interpolation. FIG. 4 shows the target values of the observed quantity at the two nodes obtained by a linear interpolation.

Point a to point t₁ constitutes the first calculation unit, point a to point t₂ constitutes the second calculation unit, point a to point b constitutes the third calculation unit, and the third calculation unit is equal to the calculation region.

First, the target shooting of the first calculation unit (i.e., the first target) is performed, and from left to right, curve 1 (FIRST SHOT) is obtained according to the trial solution of the costate variable at point a (the trial solution of the first shooting), where the value of curve 1 at point t₁ (the end point of the first calculation unit) is far away from the target value of observed quantity at point t₁. After several iterations, the continuous adjustment of the trial solution results in curve 4, where the value of curve 4 at point t₁ converges to the target value of the observed quantity at point t₁, so the trial solution of the costate variable at point a corresponding to curve 4 is the convergent solution obtained from the first shooting.

The convergent solution obtained in the first shooting is used as the initial trial solution of the second shooting, and the target shooting of the second calculation unit is performed. The value of the curve 4 (SECOND SHOT) at point t₂ corresponding to the initial trial solution is far away from the target value of the observed quantity at point t₂. Through multiple iterations, the curve 7 (THIRD SHOT) converged to the target values of the observed quantity at point t₂ is obtained. The trial solution corresponding to curve 7 is taken as the convergent solution obtained in the second shooting.

The above process is repeated, and the third shooting is carried out until curve 9 that converges to the target value of the observed quantity at point b is obtained, and the trial solution corresponding to curve 9 is taken as the convergent solution obtained by the third shooting.

The third calculation unit is the calculation region, so the convergent solution obtained by the third shooting is the deterministic solution of the costate variable at point a.

If the target of the calculation region is directly shot, the trial solution 1 of the costate variable at point a is tried. It can be predicted from the figure that the value of curve 1 at point b is far away from p, and overflow is likely to occur during the shooting process, so that the target shooting process cannot continue. It can be seen from FIG. 4 that if the initial trial solution is not appropriate, the conventional shooting process is prone to overflow and the correct solution cannot be obtained.

In one embodiment, by constructing multiple calculation units with different tracking lengths, the target shooting is started from the calculation unit with the smallest tracking length, and target shooting overflow can be well prevented due to the small tracking length even if the initial trial solution of the first target shooting is not accurate. The initial trial solution of the target shooting of the next calculating unit is obtained according to the convergence solution of the target shooting of the previous calculating unit, so that the initial trial solution used by the subsequent target shooting is closer to the true value, and the target shooting is ensured not to overflow.

The method of solving the electric field physical quantity in the negative electrode region and the positive electrode region is the same. One of the regions can be solved first, and then the other region can be solved in the same way, so as to complete the solution of the electric field physical quantity in the entire space.

In some embodiments, step S1000 includes:
if the observed quantity is the solid-phase current, the target value of the observed quantity at the i-th node is:

$$\frac{{i}_{external}}{L} \times ( L - {x}_{i} ) ,$$

wherein iₑₓₜₑᵣₙₐₗ is an external current, L is a thickness of an electrode, and x, is a distance from the i-th node to a current collector, i=1, 2, . . . , N−1.
xᵢ can be obtained by dividing the calculation region into N equal parts. The target values of the observed quantity of the above nodes are calculated according to the linear interpolation method.

In some embodiments, the method for solving electric field physical quantity also includes:
if there exists one calculation unit whose shooting overshoots or fails to converge during the target shooting process of the N calculation units, increasing the number of spatially discrete units, and re-performing steps S1000-S4000 according to the new number of spatially discrete units.

In some embodiments, step S3000 includes:

At step S3300, if said calculation unit is the first calculation unit, the initial trial solution of the shooting of said calculation unit is the deterministic solution of the costate variable of which the starting point of the calculation region is at the previous time.

The d deterministic solution of the costate variable whose starting point is at the previous time is closer to the true value, so choosing it as the initial trial solution is more conducive to the convergence of the shooting method.

In some embodiments, step S3100 includes:

At step S3110, the value of the observed quantity of the starting point of the calculation unit at the present time is obtained.

At step S3120, the costate variable of the starting point at the present time is set according to the initial trial solution of the shooting of said calculation unit.

At step S3130, the observed quantity of the end point of said calculation unit at the present time is obtained according to the observed quantity and the costate variable of the starting point at the present time and a governing equation of the electrochemical model.

At step S3140, whether an error between the observed quantity of the end point of said calculation unit at the present time and the target value of the observed quantity is within an error range is determined.

At step S3150, if the error is not within the error range, the trial solution of the costate variable according to a preset rule is updated, the costate variable of the starting point at the present time is set according to a new trial solution, and then jumping to step S3130;

At step S3160, if the error is not within the error range, the trial solution is taken as a convergent solution of the target shooting of the present calculating unit.

The error range can be set according to the accuracy requirements. If it is not within the error range, further iterations are required to adjust the current trial solution. It can be adjusted according to the difference between the value of the observed quantity at the end point of the calculation unit and the target value of the observed quantity obtained by the current trial solution. If a convergent solution can be obtained, the shooting of this calculation unit is successful.

In some embodiments, step S3130 includes:

Starting from the starting point, the observed quantity and the costate variable of the next spatial point at the present time are calculated according to the observed quantity and the costate variable of the present spatial point at the present time, the present spatial point is updated with the next spatial point, and the above process repeated until obtaining the observed quantity and the costate variable of the end point of the calculation unit at the present time.

Said calculating the observed quantity and the costate variable of the next spatial point at the present time according to the observed quantity and the costate variable of the present spatial point at the present time includes:

At step S3131, according to the solid phase potential and the liquid phase potential of the present spatial point at the present time, an overpotential of the present spatial point at the present time is obtained by the formula of:

η(x,t)=ϕₛ(x,t)−ϕₑ(x,t)−ocv(x,t);

wherein η is the overpotential, ϕₛ is the solid phase potential, ϕₑ is the liquid phase potential, ocv is an electrode steady state open circuit voltage related to a lithium-ion concentration on surfaces of solid phase particles. The distribution of ocv on the x-axis can be obtained in advance before the electric field is decoupled.

At step S3132, according to the overpotential of the present spatial point at the present time, an exchange current density jₙ of the present spatial point at the present time is obtained by the formula of:

$${j}_{n} ( x , t ) = \frac{1}{F} {j}_{0} ( x , t ) [ exp ( \frac{{α}^{+} F}{RT} η ( x , t ) ) - exp ( - \frac{{α}^{-} F}{RT} η ( x , t ) ) ] ;$$

wherein α⁺ and α⁻ are transfer coefficients, F is a Faraday constant, R is a molar gas constant, T is an absolute temperature of the battery, and j₀ is the exchanging current density for an electrode reaction in an equilibrium state.

At step S3133, according to the exchange current density of the present spatial point at the present time, the observed quantity of the next spatial point at the present time is calculated by using a difference method or a Runge-Kutta method.

The next spatial point is equal to the present spatial point plus the preset pace (step length). The exchange current density not only reflects the change of lithium-ion current per unit area, but also reflects the change of electron current. The observed quantity is the solid-phase current or the liquid-phase current. Therefore, according to the observed quantity and the exchange current density of the present spatial point, the observed quantity of the next spatial point is obtained.

At step S3134, the partial derivative of the solid-phase potential of the current spatial point at the present time is obtained according to the observed quantity of the current spatial point at the present time, and the solid-phase potential at the next spatial point is calculated according to the partial derivative of the solid-phase potential of the current spatial point at the present time by using the difference method or Runge-Kutta method.

If the observed quantity is the solid-phase current, the partial derivative of the solid-phase potential at the present spatial point at the present time can be obtained according to the formula

$$\frac{\partial {ϕ}_{s}}{\partial x} : \frac{\partial {ϕ}_{s}}{\partial x} ( x , t ) = - \frac{{i}_{s} ( x , t )}{k} ,$$

wherein iₛ is the solid phase current, k is a solid phase conductivity.

If the observed quantity is the liquid-phase current, according to iₛ(x,t)+iₑ(x,t)=iₑₓₜₑᵣₙₐₗ(t), where iₑₓₜₑᵣₙₐₗ is the external current, the solid-phase current at the present spatial point at the present time is obtained first, and then the partial derivative of the solid-phase potential at the present spatial point at the present time is obtained according to the above formula.

Using the difference method or the Runge-Kutta method, the solid-phase potential of the next spatial point can be obtained according to the solid-phase potential of the present spatial point at the present time and the partial derivative of the solid-phase potential.

At step S3135, the partial derivative of the liquid phase potential of the present spatial point at the present time is obtained, and the liquid phase potential of the next spatial point is calculated by the difference method or Runge-Kutta method according to the partial derivative of the liquid phase potential of the present spatial point at the present time.

Specifically, if the observed quantity is the solid-phase current, according to iₛ(x,t)+iₑ(x,t)=iₑₓₜₑᵣₙₐₗ(t), the liquid-phase current at the present spatial point at the present time can be obtained.

The partial derivative of the liquid phase potential at the present spatial point is obtained according to the formula of

$$\frac{\partial {ϕ}_{e}}{\partial x} : \frac{\partial {ϕ}_{e}}{\partial x} ( x , t ) = - \frac{{i}_{e} ( x , t )}{{σ}^{*} {ε}^{brug}} + \frac{2 RT}{F} ( 1 - {t}_{c} ) \frac{{o}^{⌢} {lnc}_{e}}{\partial x} ( x , t ) ,$$

wherein iₑ is the liquid phase current, t_{c} is the point mobility, cₑ is a liquid phase lithium-ion concentration, σ is a liquid phase conductivity, e is a liquid phase volume fraction, brug is a porous media coefficient.

According to the liquid phase potential of the present spatial point and the partial derivative of the liquid phase potential, the liquid phase potential of the next spatial point is calculated.

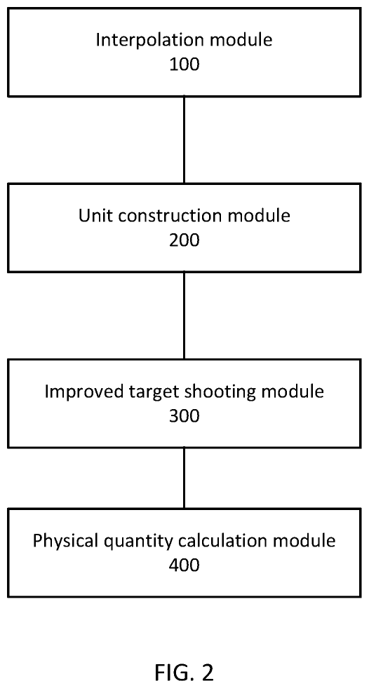

Referring to FIG. 2, a system for solving electric field physical quantity in electrochemical model is schematically shown according to one embodiment of the invention. A negative electrode region or a positive electrode region of the electrochemical model is selected as a calculation region, a solid phase current or a liquid phase current is selected as an observed quantity, and a solid-phase potential and a liquid-phase potential are selected as a costate variable.

The system comprises an interpolation module 100, a unit construction module 200, an improved target shooting module 300, and a physical quantity calculation module 400.

The interpolation module 100 is configured to insert (N−1) different nodes between two endpoints of the calculation region, and determine a target value of the observed quantity of each node according to a preset interpolation method, wherein N is a number of spatial discrete units.

The unit construction module 200 is configured to construct N calculation units, wherein each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1.

The improved target shooting module 300 is configured to complete, staring from the first calculation unit, target shooting of each of the N calculation units in turn according to an ascending order until a convergent solution of the target shooting of the N-th calculation unit is obtained, and take the convergent solution as a deterministic solution of the costate variable of the starting point at the present time.

The physical quantity calculation module 400 is configured to obtain, according to the observed quantity of the starting point at the present time and the deterministic solution of the costate variable, the electric field physical quantity of each spatial point of the calculation region at the present time.

The improved target shooting module 300 includes a target shooting unit configured to complete the shooting of each calculation unit.

The target shooting unit is also configured to perform, starting from an initial trial solution of the target shooting of said calculation unit, the target shooting of said calculation unit to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point; and if said calculation unit is not the first calculation unit, obtaining the initial trial solution of the target shooting of said calculation unit according to the convergent solution of the shooting of the previous calculation unit.

In some embodiments, the interpolation module 100 is also used to:
if the observed quantity is the solid-phase current, the target value of the observed quantity at the i-th node is:

$$\frac{{i}_{external}}{L} \times ( L - {x}_{i} ) ,$$

wherein iₑₓₜₑᵣₙₐₗ is an external current, L is a thickness of an electrode, and xᵢ is a distance from the i-th node to a current collector.

In some embodiments, the device for solving the electric field physical quantity also includes a unit number updating module used to increase the number of spatially discrete units if there exists one calculation unit whose shooting overshoots or fails to converge during the target shooting process of the N calculation units.

The interpolation module and the unit construction module are adaptively updated according to the new number of spatially discrete units.

In some embodiments, the target shooting unit is also used to set the initial trial solution of the shooting of said calculation unit to be the deterministic solution of the costate variable of which the starting point of the calculation region is at the previous time, if said calculation unit is the first calculation unit.

In some embodiments, the target shooting unit is also used to obtain a value of the observed quantity of the starting point of said calculation unit at the present time; set, according to the initial trial solution of the shooting of said calculation unit, the costate variable of the starting point at the present time; obtain, according to the observed quantity and the costate variable of the starting point at the present time and a governing equation of the electrochemical model, the observed quantity of the end point of said calculation unit at the present time; determine whether an error between the observed quantity of the end point of said calculation unit at the present time and the target value of the observed quantity is within an error range; if the error is not within the error range, update the trial solution of the costate variable according to a preset rule, set the costate variable of the starting point at the present time according to a new trial solution, obtain the observed quantity of the end point of said calculation unit at the present time according to the new trial solution, determine whether the error between the observed quantity at the present time and the target value of the observed quantity at the end point of the calculation unit is within the error range, and repeating process until the error is within the error range; and if the error is within the error range, take the trial solution as the convergent solution for shooting by the calculation unit.

The target shooting unit includes an overpotential calculation unit, an exchange current density calculation unit, a current calculation unit, and a potential calculation unit.

The overpotential calculation unit is used to obtain the overpotential of the present spatial point at the present time according to the solid phase potential and the liquid phase potential of the present spatial point at the present time.

The exchange current density calculation unit is used to obtain the exchange current density of the present spatial point at the present time according to the overpotential of the present spatial point at the present time.

The current calculation unit is used to calculate the observed quantity of the next spatial point at the present time by using the difference method or the Runge-Kutta method according to the observed quantity and the exchange current density of the current spatial point at the present time.

The potential calculation unit is used to obtain the partial derivative of the solid-phase potential of the current spatial point at the present time according to the observed quantity of the current spatial point at the present time, calculate the solid-phase potential of the next spatial point according to the partial derivative of the solid-phase potential of the current spatial point at the present time by using the difference method or the Runge-Kutta method, obtain the partial derivative of the liquid phase potential of the present spatial point at the present time according to the partial derivative of the liquid phase potential of the present spatial point at the present time by using the Runge-Kutta method.

It should be noted that the embodiment of the system for solving the electric field physical quantity in the electrochemical model provided by the invention and the embodiment of the method for solving the electric field physical quantity in the electrochemical model provided above are all according to the same inventive concept, and can obtain the same technical effects. Therefore, other specific content of the embodiment of the system for solving the electric field physical quantity in the electrochemical model can refer to the description of the content of the embodiment of the above-mentioned method for solving the electric field physical quantity in the electrochemical model.

In one embodiment, a non-transitory tangible computer-readable storage medium stores a computer program, and when the computer program is executed by a processor, the method for solving the electric field physical quantity in the electrochemical model as described in the foregoing embodiments can be realized. That is, when part or all of the technical solutions contributed by the embodiments of the invention to the prior art are embodied in the form of computer software products, the foregoing computer software products are stored in a computer-readable storage medium. The computer-readable storage medium may be any portable computer program code entity or device. For example, the computer-readable storage medium may be a USB flash drive, a removable disk, a magnetic disk, an optical disk, a computer memory, a read-only memory, a random access memory, and the like.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A method for solving electric field physical quantity in an electrochemical model, comprising:
selecting a negative electrode region or a positive electrode region of the electrochemical model as a calculation region;
selecting a solid phase current or a liquid phase current as an observed quantity, and a solid-phase potential and a liquid-phase potential as a costate variable;
inserting (N−1) different nodes between two endpoints of the calculation region, and determining a target value of the observed quantity of each node according to a preset interpolation method, wherein N is a number of spatial discrete units;
constructing N calculation units, wherein each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1;
sequentially completing target shooting of each of the N calculation units according to an ascending order, starting from the first calculation unit, until a convergent solution of the target shooting of the N-th calculation unit is obtained, and taking the convergent solution as a deterministic solution of the costate variable of the starting point at the present time; and
obtaining, according to the observed quantity of the starting point at the present time and the deterministic solution of the costate variable, the electric field physical quantity of each spatial point in the calculation region at the present time;
wherein the target shooting of each calculation unit includes:
performing the target shooting of said calculation unit, starting from an initial trial solution of the target shooting of said calculation unit, to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point; and
if said calculation unit is not the first calculation unit, obtaining the initial trial solution of the target shooting of said calculation unit according to the convergent solution of the shooting of the previous calculation unit.

2. The method of claim 1, wherein said determining the target value of the observed quantity of each node according to the preset interpolation method comprises:
constructing an interpolation function according to the preset interpolation method, wherein values of the interpolation function at the two endpoints of the calculation region are respectively equal to boundary values of the observed quantity in the calculation region, and wherein the preset interpolation method is one of a linear interpolation method, a Lagrange interpolation method and a Newton interpolation method; and
calculating the target value of the observed quantity of each node according to the interpolation function.

3. The method of claim 2, wherein said calculating the target value of the observed quantity of each node according to the interpolation function comprises:
if the observed quantity is the solid-phase current, the target value of the observed quantity at the i-th node is:
$$\frac{{i}_{external}}{L} \times ( L - {x}_{i} ) ,$$
wherein iₑₓₜₑᵣₙₐₗ is an external current, L is a thickness of an electrode, and x, is a distance from the i-th node to a current collector.

4. The method of claim 1, further comprising:
if there exists one calculation unit whose shooting overshoots or fails to converge during the target shooting process of the N calculation units, increasing the number of spatially discrete units, reconstructing all the calculation units according to the new number of spatially discrete units, and re-performing the target shooting process starting from the first calculation unit.

5. The method of claim 1, wherein the target shooting of each calculation unit further includes:
if said calculation unit is the first calculation unit, the initial trial solution of the shooting of said calculation unit is the deterministic solution of the costate variable of which the starting point of the calculation region is at the previous time.

6. The method of claim 1, wherein said performing the target shooting of said calculation unit, from the initial trial solution of the target shooting of said calculation unit, to obtain the convergent solution of the target shooting of said calculation unit comprises:
(a) obtaining a value of the observed quantity of the starting point of said calculation unit at the present time;
(b) setting, according to the initial trial solution of the shooting of said calculation unit, the costate variable of the starting point at the present time;
(c) obtaining, according to the observed quantity and the costate variable of the starting point at the present time and a governing equation of the electrochemical model, the observed quantity of the end point of said calculation unit at the present time;
(d) determining whether an error between the observed quantity of the end point of said calculation unit at the present time and the target value of the observed quantity is within an error range;
(e) if the error is not within the error range, updating the trial solution of the costate variable according to a preset rule, setting the costate variable of the starting point at the present time according to a new trial solution, obtaining the observed quantity of the end point of said calculation unit at the present time according to the new trial solution, determining whether the error between the observed quantity at the present time and the target value of the observed quantity at the end point of the calculation unit is within the error range, and repeating process (a)-(d) until the error is within the error range; and
if the error is within the error range, taking the trial solution as the convergent solution for shooting by the calculation unit.

7. The method of claim 6, wherein said obtaining, according to the observed quantity and the costate variable of the starting point at the present time and the governing equation of the electrochemical model, the observed quantity of the end point of said calculation unit at the present time comprises:
calculating, from the starting point, the observed quantity and the costate variable of the next spatial point at the present time according to the observed quantity and the costate variable of the present spatial point at the present time, updating the present spatial point with the next spatial point, and repeating the process until the observed quantity and the costate variable of the end point of said calculation unit at the present time are obtained.

8. The method of claim 7, wherein said calculating the observed quantity and the costate variable of the next spatial point at the present time according to the observed quantity and the costate variable of the present spatial point at the present time comprises:
according to the solid phase potential and the liquid phase potential of the present spatial point at the present time, obtaining an overpotential of the present spatial point at the present time by a formula of:
η(x,t)=ϕₛ(x,t)−ϕₑ(x,t)−ocv(x,t);
wherein η is the overpotential, ϕₛ is the solid phase potential, ϕₑ is the liquid phase potential, ocv is an electrode steady state open circuit voltage related to a lithium-ion concentration on surfaces of solid phase particles;
according to the overpotential of the present spatial point at the present time, obtaining an exchange current density of the present spatial point at the present time by a formula of:
$${j}_{n} ( x , t ) = \frac{1}{F} {j}_{0} ( x , t ) [ exp ( \frac{{α}^{+} F}{RT} η ( x , t ) ) - exp ( - \frac{{α}^{-} F}{RT} η ( x , t ) ) ] ;$$
wherein α⁺ and α⁻ are transfer coefficients, F is a Faraday constant, R is a molar gas constant, T is an absolute temperature of the battery, and j₀ is the exchanging current density for an electrode reaction in an equilibrium state;
according to the exchange current density of the present spatial point at the present time, calculating the observed quantity of the next spatial point at the present time by using a difference method or a Runge-Kutta method;
according to the observed quantity of the present spatial point at the present time, obtaining a partial derivative of the solid-phase potential of the present spatial point at the present time by a formula of:
$$\frac{\partial {ϕ}_{s}}{\partial x} ( x , t ) = - \frac{{i}_{s} ( x , t )}{k}$$
wherein iₛ is the solid phase current, k is a solid phase conductivity;
calculating the solid phase potential of the next spatial point by using the difference method or the Runge-Kutta method according to the partial derivative of the solid phase potential of the present spatial point at the present time;
obtaining a partial derivative of the liquid phase potential of the present spatial point at the present time according to a formula of:
$$\frac{\partial {ϕ}_{e}}{\partial x} ( x , t ) = - \frac{{i}_{e} ( x , t )}{{σ}^{*} {E}^{brug}} + \frac{2 RT}{F} ( 1 - {t}_{c} ) \frac{\partial {lnc}_{e}}{\partial x} ( x , t )$$
wherein iₑ is the liquid phase current, t_{c} is the point mobility, cₑ is a liquid phase lithium-ion concentration, σ is a liquid phase conductivity, ε is a liquid phase volume fraction, brug is a porous media coefficient; and
calculating the liquid phase potential of the next spatial point by using the difference method or the Runge-Kutta method according to the partial derivative of the liquid phase potential of the present spatial point at the present time.

9. A system for solving electric field physical quantity in an electrochemical model, wherein a negative electrode region or a positive electrode region of the electrochemical model is selected as a calculation region, a solid phase current or a liquid phase current is selected as an observed quantity, and a solid-phase potential and a liquid-phase potential are selected as a costate variable, the system comprising:
an interpolation module, configured to insert (N−1) different nodes between two endpoints of the calculation region, and determine a target value of the observed quantity of each node according to a preset interpolation method, wherein N is a number of spatial discrete units;
a unit construction module, configured to construct N calculation units, wherein each calculation unit has a starting point that is a starting point of the calculation region, and an end point that is one of the (N−1) nodes or an end point of the calculation region, wherein a spatial region of the i-th calculation unit is a subset of a spatial region of the (i+1)-th calculation unit, i=1, 2, . . . , N−1;
an improved target shooting module, configured to complete, staring from the first calculation unit, target shooting of each of the N calculation units in turn according to an ascending order until a convergent solution of the target shooting of the N-th calculation unit is obtained, and take the convergent solution as a deterministic solution of the costate variable of the starting point at the present time; and
a physical quantity calculation module, configured to obtain, according to the observed quantity of the starting point at the present time and the deterministic solution of the costate variable, the electric field physical quantity of each spatial point of the calculation region at the present time;
wherein the improved target shooting module includes:
a target shooting unit, configured to complete the shooting of each calculation unit,
wherein the target shooting unit is further configured to perform, starting from an initial trial solution of the target shooting of said calculation unit, the target shooting of said calculation unit to obtain the convergent solution of the target shooting of said calculation unit, wherein the convergent solution is a trial solution of the costate variable at the starting point that makes the observed quantity at the end point of said calculation unit converge to the target value of the observed quantity of the corresponding point; and
if said calculation unit is not the first calculation unit, obtaining the initial trial solution of the target shooting of said calculation unit according to the convergent solution of the shooting of the previous calculation unit.

10. A non-transitory tangible computer-readable storage medium, storing a computer program therein, wherein when the computer program is executed by a processor, the method for solving electric field physical quantities in the electrochemical model according claim 1 is realized.
